(19) United States
(12) Patent Application Publication
(10) Pub. No.: US 2015/0226913 A1
(43) Pub. Date: Aug. 13, 2015

(54) LIGHTING DEVICE, DISPLAY DEVICE AND TELEVISION DEVICE

(71) Applicant: Sharp Kabushiki Kaisha, Osaka-shi, Osaka (JP)

(72) Inventor: Takaharu Shimizu, Osaka-shi (JP)

(21) Appl. No.: 14/416,096

(22) PCT Filed: Jul. 30, 2013
(86) PCT No.: PCT/JP2013/070578

§ 371 Date: Jan. 21, 2015

(30) Foreign Application Priority Data
Aug. 3, 2012 (JP) 2012-172785

(51) Int. Cl. F21V 8/00; H04N 5/64

(52) U.S. Cl. CPC G02B 6/0086; G02B 6/0085; G02B 6/0031; G02B 6/0065; H04N 5/64

(57) ABSTRACT

A backlight unit 24 includes LEDs 28, a light guide plate 20, a heat dissipation member 36, LED boards 30, and adhesive tapes 38. The light guide plate 20 includes a front surface configured as a light exit surface 20b, a rear plate surface as an opposite surface 20c that is opposite from the light exit surface 20b, long side-surfaces configured as light entrance surfaces 20a. The light guide plate 20 is arranged such that the light entrance surface 20a faces the LEDs 28 and configured to guide light from the LEDs 28. The heat dissipation member 36 includes at least a plate-like portion 36a arranged adjacent to the opposite surface 20c and has heat dissipation properties. Each LED board 30 includes an opposed surface 30a1 that is opposed to the opposite surface 20c and arranged on the plate-like portion so as to be slidable with respect to a direction perpendicular to the light entrance surface 20a. The LEDs 28 are mounted on a mounting portion 30b of the heat dissipation member 36. The adhesive tapes 38 are arranged between the opposite surface 20c and the opposed surface 30a1. The LED boards 30 are attached to the light guide plate with the adhesive tapes 38.

### TECHNICAL FIELD

The present invention relates to a lighting device, a display device, and a television device.

### BACKGROUND ART

Displays in image display devices, such as television devices, are now being shifted from conventional cathode-ray tube displays to thin displays, such as liquid crystal displays and plasma displays. With the thin displays, the thicknesses of the image display devices can be reduced. Liquid crystal panels included in the liquid crystal display devices do not emit light, and thus backlight devices are required as separate lighting devices. An edge light-type backlight device including a light guide plate with a light entrance surface on the side and light sources such as LEDs arranged closer to the side of the light guide plate is known as an example of such backlight devices.

In the edge-light type backlight unit, it is required to improve light entering efficiency by reducing a distance between the light sources and the light entrance surface of the light guide plate. If the light sources are too close to the light entrance surface, the light entrance surface may come in contact with the light sources when thermal expansion of the light guide plate occurs. This may damage the light sources. Therefore, a predetermined distance is required between the light sources and the light entrance surface of the light guide plate.

Patent document 1 discloses an edge-light type lighting device in which light entrance efficiency is improved. In the lighting device, the position of a light guide plate is fixed by locking the light guide plate with respect to a direction perpendicular to the light entrance surface. According to this configuration, a shift in position of the light guide plate is less likely to occur even if thermal expansion of the light guide plate occurs. In other words, even if the light guide plate thermally expands, the light entrance surface is less likely to come in contact with the light sources. Therefore, the lighting device has a configuration in which the distance between the light sources and the light entrance surface of the light guide plate is reduced and thus the light entering efficiency of light emitted from the light source is improved.

### RELATED ART DOCUMENT

### Patent Document

Patent Document 1: Japanese Unexamined Patent Application Publication No. 2011-150264

### Problem to be Solved by the Invention

The backlight device of the Patent document 1 does not include a proper configuration for releasing heat generated around the light sources. While the light sources are on, heat may stay inside the housing. If heat stays inside the housing, a temperature within the housing increases and this may be factors to cause several defects.

### DISCLOSURE OF THE PRESENT INVENTION

The technology described in this specification was made in view of the foregoing circumstances. An object is to provide a lighting device having heat dissipation properties and in which light entering efficiency of light emitted from a light source into a light entrance surface of a light guide plate is improved.

### Means for Solving the Problem

Technologies described herein are related to a lighting device having the following configurations. The lighting device includes alight source, alight guide plate, alight source board, a heat dissipation member, and an adhesive tape. The light guide plate includes a plate surface configured as a light exit surface, another plate surface as an opposite surface that is opposite from the light exit surface, and at least one side surface configured as a light entrance surface. The light guide plate is arranged such that the light entrance surface is opposite the light source and configured to guide light from the light source. The heat dissipation member having a heat dissipation property includes at least one plate-like portion arranged adjacent to the opposite surface. The light source board includes an opposed surface that is opposite the opposite surface. The light source board is arranged on the plate-like portion so as to be slidable in a direction perpendicular to the light entrance surface. The light source is mounted to a portion of the light source board. The adhesive tape is arranged between the opposite surface and the opposed surface. The light source board is attached to the light guide plate with the adhesive tape.

According to the lighting device, the light source board is attached to the light guide plate with the adhesive tape and thus the light source board is fixed to the light guide plate. According to this configuration, a distance between the light source and the light entrance surface is maintained. The light source board is arranged so as to be slidable on the plate-like portion. If the light entrance surface of the light guide plate thermally expands toward the light source, the light source board that is fixed to the light guide plate moves according to the thermal expansion of the light guide plate. Therefore, a distance between the light source and the light entrance surface remains constant before and after the thermal expansion. In this configuration, a predetermined distance is not required between the light source and the light entrance surface for a supposed thermal expansion of the light guide plate. Therefore, the light source can be arranged close to the light entrance surface and thus light entering efficiency of light from the light source into the light entrance surface is improved. Furthermore, the light source board is arranged on the heat dissipation member having a heat dissipation property. Therefore, heat generated around the light source is effectively dissipated via the heat dissipation member. According to this configuration, while the lighting device has the heat dissipation property, the light entering efficiency of the light emitted from the light source into the light entrance surface is improved.

A pair of the adhesive tapes may be arranged between the opposite surface and the opposed surface. The lighting device may further include a reflection member arranged between the pair of the adhesive tapes. The reflection member may include an edge portion that extends closer to the light source than the light entrance surface of the light guide plate is.

According to this configuration, light that exits the light source and travels to the opposed surface is reflected by the extending portion of the reflection member and directed toward the light entrance surface. Therefore, the light entering efficiency of light emitted from the light source into the light entrance surface is further improved.

The light source board may include a mounting portion where the light source is mounted. The mounting portion may have a plate-like shape and extend from the opposed surface toward a light exit surface side.

In this configuration, the edge portion of the reflection member can be extended to a position between the light source and the opposed surface (i.e., immediately below the light source). Therefore, light from the light source is effectively reflected toward the light entrance surface by the reflection member.

The light source may be mounted on the opposed surface in a standing position. The light source includes a light emitting surface on a side surface thereof.

According to this configuration, the light source board does not need a portion that extends from the opposed surface and to which the light source are attached. In this configuration, a bending work is not required for the light source board and thus the production cost can be reduced.

The lighting device may further include a chassis that holds at least the light source, the light guide plate, and the light source board. The heat dissipation member may be configured as a portion of the chassis.

According to this configuration, the heat dissipation member and the chassis are connected together to form a single component. Therefore, reduction in thickness of the lighting device is accomplished.

The light source board may be made of aluminum.

According to this configuration, the light source board is a member having high thermal conductivity. Therefore, heat generated from the light source is effectively transferred to the heat dissipation member via the light source board.

The light guide plate may include a plurality of side surfaces each configured as the light entrance surface.

According to this configuration, the light sources are arranged corresponding to multiple light entrance surfaces. The light sources are arranged close to each of the light entrance surfaces and thus light entering efficiency of light into each of the light entrance surfaces is improved. Therefore, brightness of the lighting device is improved.

The technologies described in this specification may be applied to a display device including a display panel configured to provide display using light from the above-described lighting device. A display device that includes a liquid crystal panel as such a display panel may be considered as new and advantageous. Furthermore, a television device including the above-described display device may be considered as new and advantageous. In the above-described display device or the above-described television device, a display area can be increased.

### Advantageous Effect of the Invention

According to the technologies described in this specification, a lighting device having heat dissipation properties and improved light entering efficiency of light emitted from a light source into light entrance surface of a light guide plate is provided.

### BRIEF DESCRIPTION OF THE DRAWINGS

FIG. 1 is an exploded perspective view illustrating a general configuration of a television device TV according to a first embodiment of the invention.

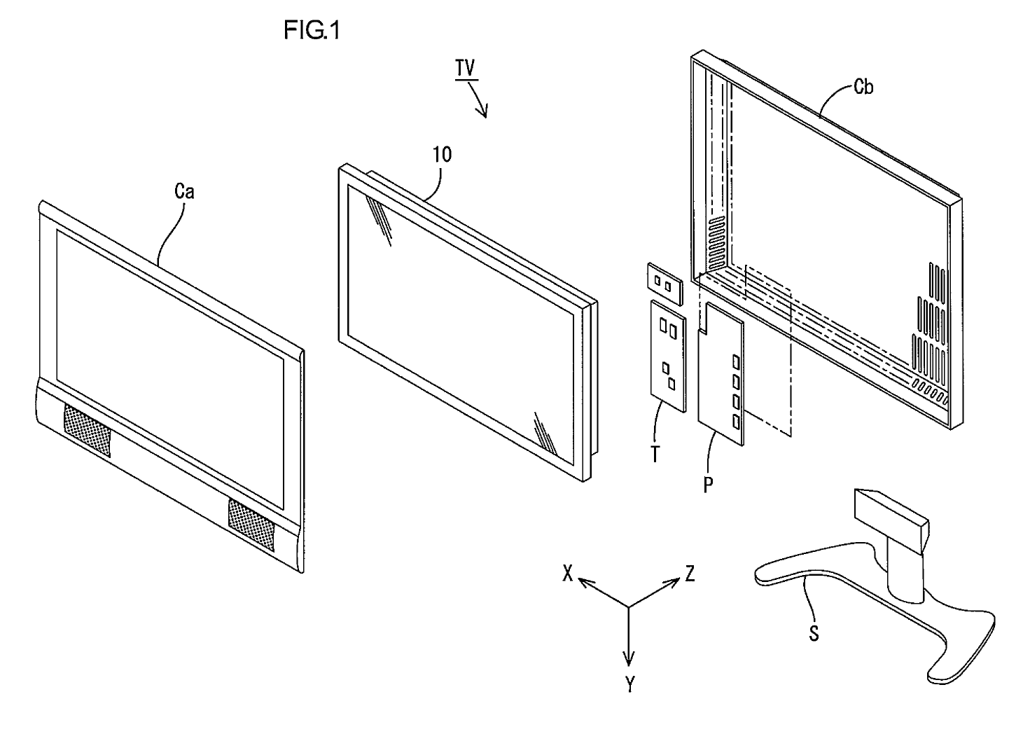

FIG. 2 is an exploded perspective view of a liquid crystal display device 10 illustrating a general configuration of the liquid crystal display device 10.

FIG. 3 is a cross-sectional view of the liquid crystal display device 10 along a short-side direction thereof illustrating a cross-sectional configuration.

FIG. 4 is a magnified cross-sectional view of a relevant portion of the liquid crystal display device 10 in FIG. 3 illustrating adhesive tapes 38 and therearound.

FIG. 5 is a magnified perspective front view of a light guide plate 20, illustrating a light entrance surface 20a and its vicinity.

FIG. 6 is a cross-sectional view of a liquid crystal display device 110 according to a second embodiment taken along a short-side direction thereof, illustrating a cross-sectional configuration.

FIG. 7 is a magnified cross-sectional view of a relevant portion of the liquid crystal display device 10 in FIG. 6, illustrating adhesive tapes 138 and its vicinity.

FIG. 8 is a magnified cross-sectional view of a relevant portion of a liquid crystal display device 210 according to a third embodiment, illustrating adhesive tapes 238 and its vicinity.

FIG. 9 is a magnified cross-sectional view of a relevant portion of a liquid crystal display device 310 according to a fourth embodiment, illustrating adhesive tapes 338 and its vicinity

FIG. 10 is an exploded perspective view illustrating a general configuration of a liquid crystal display device 410 according to a fifth embodiment.

### MODE FOR CARRYING OUT THE INVENTION

A first embodiment will be described with reference to the drawings. In the following description, a liquid crystal display device 10 will be described. X-axes, Y-axes and Z-axes are provided in portions of the drawings, respectively. The axes in each drawing correspond to the respective axes in other drawings. The X-axes and Y-axes are aligned with the horizontal direction and the vertical direction, respectively. In the following description, the top-bottom direction corresponds to the vertical direction unless otherwise specified.

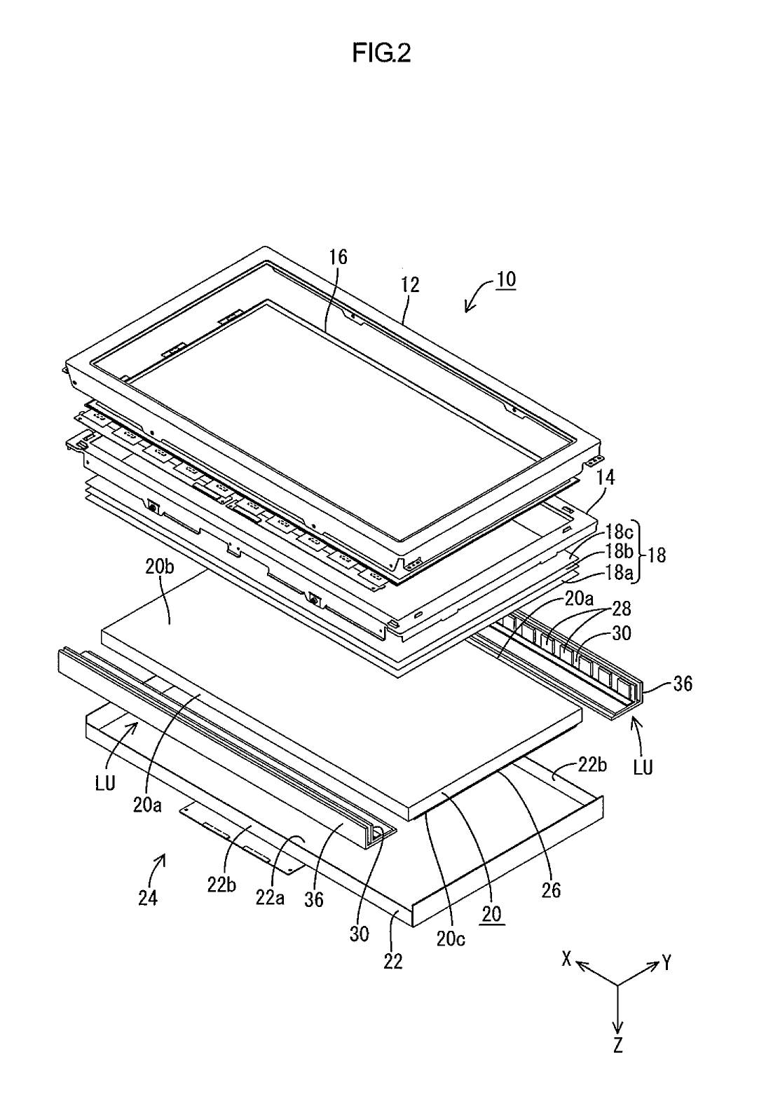

A television device TV includes the liquid crystal display device (an example of a display device) 10, front and rear cabinets Ca, Cb that hold the liquid crystal display device 10 therebetween, a power source P, a tuner T, and a stand S. In FIG. 2, the upper side and the lower side correspond to the front side and the rear side of the liquid crystal display device 10, respectively. As illustrated in FIG. 2, an overall shape of the liquid crystal display device 10 is a landscape rectangular. The liquid crystal display device 10 includes a liquid crystal panel 16 and a backlight unit (an example of a lighting device) 24. The liquid crystal panel 16 is a display panel and the backlight unit 24 is an external light source. The liquid crystal panel 16 and the backlight unit 24 are integrally held with a bezel 12 having a frame-like shape.

As illustrated in FIG. 2, components of the liquid crystal display device 10 are arranged in a space provided between the bezel 12 that provides a front external configuration and a chassis 22 that provides a rear external configuration. The components arranged between the bezel 12 and the chassis 22 are at least the liquid crystal panel 16, a frame 14, an optical member 18, a light guide plate 20, and LED units LU. The frame 14 having a frame-like shape is arranged along edge areas of a front surface of the light guide plate 20 (a light exit surface 20b). The frame 14 supports the liquid crystal panel 16 with inner edge portions of the frame 14. The liquid crystal panel 16 and the optical member 18 are apart from each other with the inner edge portions of the frame 14 therebetween. The optical member 18 is placed on the light guide plate 20. The backlight unit 24 includes the optical member 18, the light guide plate 20, the LED units LU, and the chassis 22. Namely, the liquid crystal display device 10 without the bezel 12, the liquid crystal panel 16 and the frame 14 is the backlight unit 24. The backlight unit 24 includes LED boards 30 that are arranged in the chassis 22 so as to face respective long-side edge surfaces of the light guide plate 20. Each component will be described next.

The liquid crystal panel 16 includes a pair of transparent glass substrates (having a high light transmission capability) and a liquid crystal layer (not illustrated). The glass substrates are bonded together with a predetermined gap therebetween. The liquid crystal layer is sealed between the glass substrates. On one of the glass substrates, switching components (e.g., TFTs) connected to source lines and gate lines that are perpendicular to each other, pixel electrodes connected to the switching components, and an alignment film are provided. On the other substrate, a color filter having color sections such as R (red), G (green) and B (blue) color sections arranged in a predetermined pattern, counter electrodes and an alignment film are provided. Image data and various control signals are transmitted from a driver circuit board (not illustrated) to the source lines, the gate lines, and the counter electrodes for displaying images. Polarizing plates (not illustrated) are attached to outer surfaces of the glass substrates.

As illustrated in FIG. 2, similar to the liquid crystal panel 16, the optical member 18 has a landscape rectangular shape in a plan view and has the same size (i.e., a short-side dimension and a long-side dimension) as the liquid crystal panel 16. The optical member 18 is placed on a front surface of the light guide plate 20 (i.e., the light exit surface 20b). The optical member 18 includes three sheets that are placed on top of one another. Specifically, a diffuser sheet 18a, a lens sheet (a prism sheet) 18b, and a reflecting type polarizing sheet 18c are placed on top of one another in this sequence from the rear side (the light guide plate 16 side). Each of the three sheets 18a, 18b, and 18c has the substantially same size in a plan view.

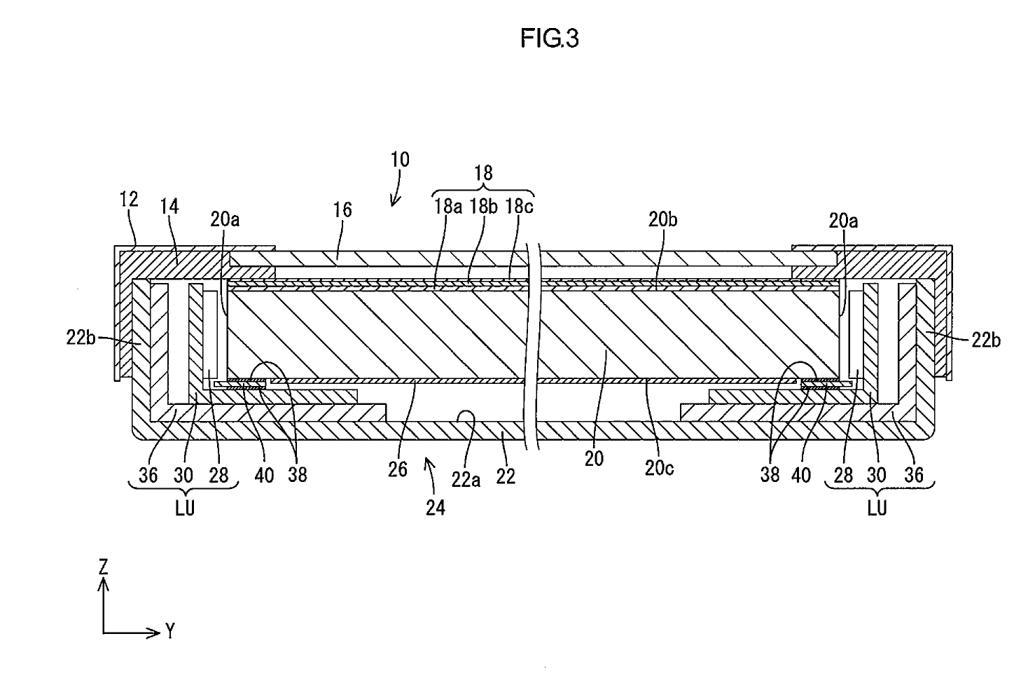

The light guide plate 20 is made of substantially transparent (high light transmissivity) synthetic resin (e.g. acrylic resin or polycarbonate such as PMMA) which has a refractive index sufficiently higher than that of the air. As illustrated in FIG. 2, the light guide plate 20 has a landscape rectangular shape in a plan view similar to the liquid crystal panel 16 and the optical member 18. A thickness of the light guide plate 20 is larger than a thickness of the optical member 18. A long-side direction and a short-side direction of a main surface of the light guide plate 20 correspond to the X-axis direction and the Y-axis direction, respectively. A thickness direction of the light guide plate 20 that is perpendicular to the main surface of the light guide plate 20 corresponds to the Z-axis direction. The light guide plate 20 is arranged on the rear side of the optical member 18 and spaced away from a bottom plate 22a of the chassis 22. As illustrated in FIG. 3, at least a short-side dimension of the light guide plate 20 is the same as short-side dimensions of the liquid crystal panel 16 and the optical member 18. The LED units LU are arranged on sides of the short dimension of the light guide plate 16 so as to have the light guide plate 20 between the LED units LU in the Y-axis direction. Rays of light from the LEDs 28 enter the light guide plate 20 through the respective ends of the short-side dimension of the light guide plate 20. The light guide plate 20 is configured to guide the rays of light, which are from the LEDs 28 and enter the light guide plate 20 through the ends of the short dimension thereof, toward the optical member 18 (on the front side). In the backlight unit 24 according to this embodiment, the light guide plate 20 and the optical member 18 are arranged behind the liquid crystal panel 16 and the LED units LU, which are light sources, are arranged at the side edges of the light guide plate 20. Namely, an edge lighting method (a side lighting method) is adapted to the backlight unit 24.

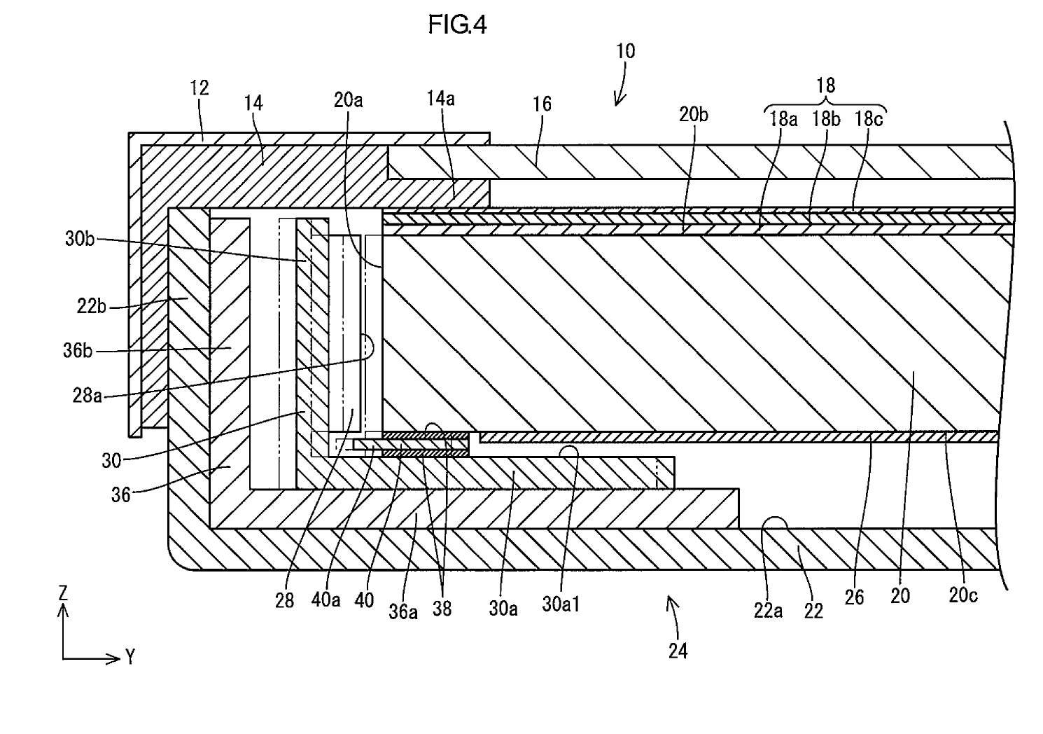

One of main surfaces of the light guide plate 20 facing the front side (a surface opposite the optical member 18) is the light exit surface 20b. Light exits the light guide plate 20 through the light exit surface 20b toward the optical member 18 and the liquid crystal panel 16. The light guide plate 20 includes edge surfaces that are adjacent to the main surfaces of the light guide plate 20. Two of the edge surfaces on the long sides (i.e., end surfaces of the short dimension) which have elongated shapes along the X-axis direction are opposite the LEDs 28. The edge surfaces on the long sides are the light entrance surfaces 20a. As illustrated in FIG. 4, a reflection sheet 20 is arranged on the rear side of the light guide plate 20, which is, on an opposite surface 20c that is opposite from the light exit surface 20b (a surface opposite the chassis 22). The reflection sheet 26 is arranged to cover substantially an entire area of the opposite surface 20c. On long-side edge portions of the opposite surface 20c, adhesive tapes 38, which will be described later, are attached.

The reflection sheet 20 is in contact with the opposite surface 20c of the light guide plate 20 but apart from bottom plate portions 36a of heat dissipation members 36 and the bottom plate 22a of the chassis 22. The reflection sheet 26 is made of synthetic resin and has a white surface that has high light reflectivity. In this configuration, light that exits the light guide plate 20 through the opposite surface 20c toward the rear side is reflected by the reflection sheet 26 toward the front side. The reflection sheet 26 has a short-side dimension smaller than a short-side dimension of the light guide plate 20.

As illustrated in FIG. 2, an overall shape of the chassis 22 is landscape rectangular and box-like to cover a substantially overall areas of the light guide plate 20 and the LED units LU from the rear side. The chassis 22 is made of metal, for instance, aluminum-based material. The chassis 22 includes the bottom plate 22a, sidewalls 22b, 22b that upstand from the respective long edges of the bottom plate 22a, and sidewalls that upstand from the respective short edges of the bottom plate 22a. In the chassis 22, space between the LED units LU, LU is a holding space for the light guide plate 20. A power supply circuit board for supplying power to the LED units LU is mounted to the back surface of the bottom plate 22a (not illustrated).

Next, configurations of the LEDs 28, the LED boards 30, and heat dissipation members 36 included in the LED units LU will be described. Each of the LEDs 28 of the LED units LU includes an LED chip (not illustrated). The LED chips are mounted on boards that are attached on a surface of a mounting portion 30b of the LED board 30, which will be described later, opposite the light guide plate 20. The LED chips are sealed with resin. The LED chip mounted on the board has one main light emission wavelength. Specifically, the LED chip that emits light in a single color of blue is used. The resin that seals the LED chip contains phosphors dispersed therein. The phosphors emit light in a predetermined color when excited by blue light emitted from the LED chip. Thus, overall color of light emitted from the LED 28 is white. The phosphors may be selected, as appropriate, from yellow phosphors that emit yellow light, green phosphors that emit green light, and red phosphors that emit red light. The phosphors may be used in combination of the above phosphors or one single one of the phosphors may be used. Each LED 28 has a rectangular shape in a front view. The LED 28 includes a main light-emitting surface 28a that is opposite the light entrance surface 20a of the light guide plate 20. Namely, the LED 28 is a so-called top-surface-emitting type LED having a light distribution according to the Lambertian distribution. The LED 28 has a long dimension in the Z-axis direction substantially the same as a thickness of the light guide plate 20. The LED 28 includes a front side-surface and a rear side-surface. The position of the front side-surface with respect to the Z-axis direction is aligned with the position of the light exit surface 20b of the light guide plate 20 (refer to FIG. 4). The position of the rear side-surface with respect to the Z-axis direction is aligned with the position of the opposite surface 20c of the light guide plate 20. As illustrated in FIG. 4, the main light-emitting surfaces 28a of the LEDs 28 are located close to the light entrance surface 20a of the light guide plate 20. With this configuration, high light entering efficiency of light from the LEDs 28 into the light entrance surface 20a is achieved.

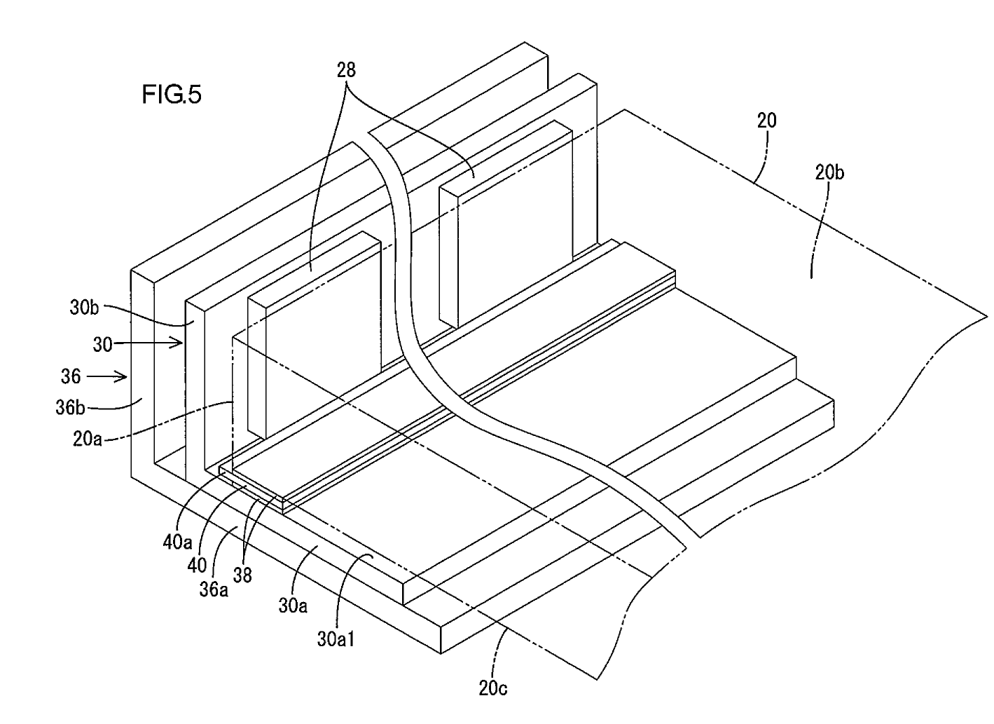

The LED boards 30 of the LED units LU are made of aluminum and have high heat dissipation properties. As illustrated in FIGS. 4 and 5, the LED board 30 includes a heat dissipating portion 30a and the mounting portion 30b that form an angle therebetween so as to have an L-like shape in a cross-section. The heat dissipating portion 30a is in surface-contact with a plate-like portion 36a of the heat dissipation member 36, which will be described later. The mounting portion 30b is a portion to which the LEDs 28 are attached. The LED board 30 has a long-side dimension substantially the same as the long-side dimension of the light guide plate 20. As illustrated in FIGS. 4 and 5, the mounting portion 30b has a plate-like shape parallel to the light entrance surface 16b of the light guide plate 16. A long-side direction, a short-side direction, and a thickness direction of the mounting portion 30b correspond to the X-axis direction, the Z-axis direction, and the Y-axis direction, respectively. The LEDs 28 are mounted on an inner plate surface of the mounting portion 30b, that is, a plate surface that faces the light guide plate 20. While the mounting portion 30b has the long-side dimension that is substantially the same as the long-side dimension of the light guide plate 20, a short-side dimension of the mounting portion 30b is larger than the thickness of the light guide plate 20. An edge portion of the short dimension of the mounting portion 30b (i.e., an edge on the rear side) extends outward in the Z-axis direction over the opposite surface 20c of the light guide plate 20. An outer plate surface of the mounting portion 30b, that is, a plate surface of the mounting portion 30b opposite from the plate surface on which the LEDs 28 are mounted, faces a stand-up portion 36b of the heat dissipation member 36, which will be described later.

As illustrated in FIGS. 4 and 5, the heat dissipating portion 30a of the LED board 30 has a plate-like shape that is parallel to the opposite surface 20c of the light guide plate 20. A long-side direction, a short-side direction, and a thickness direction of the heat dissipating portion 30a correspond to the X-axis direction, the Y-axis direction, and the Z-axis direction, respectively. The heat dissipating portion 30a extends inward from the rear edge of the mounting portion 30b (an edge of the mounting portion 30b on the chassis 22 side) in the Y-axis direction. In other words, the heat dissipating portion 30a extends toward an inner portion of the light guide plate 20. The heat dissipating portion 30a has a long-side dimension substantially the same as the long-side dimension of the mounting portion 30b. A front surface of the heat dissipating portion 30a is an opposed surface 30a1 that faces the opposite surface 20c of the light guide plate 20. A portion of the opposed surface 30a1 is located behind the reflection sheet 26. On another portion of the opposed surface 30a1, the adhesive tape 38, which will be described later, is attached. The opposed surface 30a1 and the opposite surface 20c of the light guide plate 20 are attached to the adhesive tapes 38, and thus the heat dissipating portion 30a is fixed to the opposite surface 20c. An overall area of a rear plate surface of the heat dissipating portion 30a, that is, a plate surface of the heat dissipating portion 30a that faces the heat dissipation member 36, is in surface-contact with a plate surface of the heat dissipation member 36 (specifically, a plate surface of the plate-like portion 36a). Although the heat dissipating portion 30a is in surface-contact with the plate-like portion 36a of the heat dissipation member 36, the heat dissipating portion 30a is not fixed to the heat dissipation member 36. Therefore, the heat dissipating portion 30a is slidable on the plate-like portion 36a of the heat dissipation member 36 with respect to a direction perpendicular to the light entrance surface 20a (i.e. the Y-axis direction). With the heat dissipating portions 30a that are entirely in surface-contact with the plate surface of the chassis 22, heat generated from the LEDs 28 that are turned on is effectively transferred to the heat dissipation member 36 via the mounting portion 30b and the heat dissipating portion 30a.

The heat dissipation member 36 of the LED unit LU is made of metal having high thermal conductivity, such as aluminum. As illustrated in FIGS. 4 and 5, the heat dissipation member 36 has a size slightly larger than the LED board 30. The heat dissipation member 36 includes the plate-like portion 36a and the stand-up portion 36b. Similar to the LED boards 30, the plate-like portion 36a and the stand-up portion 36b form an angle therebetween so as to have an L-like shape in a cross-section. As illustrated in FIGS. 4 and 5, the stand-up portion 36b extends from an outer edge of the plate-like portion 36a, which will be described later, in the Z-axis direction toward the front side, that is, toward the frame 14. The stand-up portion 36b has a plate-like shape that is parallel to the light entrance surface 20a of the light guide plate 20. A long-side direction, a short-side direction, and a thickness direction of the stand-up portion 36b are aligned with the X-axis direction, the Z-axis direction, and the Y-axis direction, respectively. The stand-up portion 36b includes an inner surface, that is, a plate surface that faces the light guide plate 20. The inner surface of the stand-up portion 36b is opposite a surface of the mounting portion 30b of the LED board 30 opposite from the surface on which the LEDs 28 are mounted. The stand-up portion 36b has a long-side dimension that is substantially equal to the long-side dimension of the mounting portion 30b of the LED board 30. A short-side dimension of the stand-up portion 36b is larger than a short-side dimension of the mounting portion 30b of the LED board 30. Therefore, an edge of the short dimension of the stand-up portion 36b (an edge on the rear side) protrudes in the Z-axis direction over the mounting portion 30b. Entire outer plate surfaces of the stand-up portions 36b, which are plate surfaces opposite from the surfaces that face the mounting portions 30b, are in surface-contact with inner surfaces of the corresponding long-side sidewalls 22b of the chassis 22.

As illustrated in FIGS. 4 and 5, the plate-like portion 36a has a plate-like shape and is parallel to the bottom plate 22a of the chassis 22. A long-side direction, a short-side direction, and a thickness direction of the plate-like portion 36a are aligned with the X-axis direction, the Y-axis direction, and the Z-axis direction, respectively. The plate-like portion 36a extends inward from the rear edge of the stand-up portion 36b (an edge of the stand-up portion 36b on the chassis 22 side) in the Y-axis direction. In other words, the plate-like portion 36a extends toward an inner portion of the light guide plate 20. A large portion of the plate-like portion 36a is in surface-contact with a rear surface of the heat dissipating portion 30a. In other words, a large portion of the plate-like portion 36a is sandwiched (located) between the LED board 30 and the chassis 22. An entire rear plate surface of the plate-like portion 36a, i.e., a plate surface of the plate-like portion 36a that faces the chassis 22, is in surface-contact with the plate surface of the bottom plate 22a of the chassis 22. With the plate-like portions 36a of the heat dissipation members 36 that are screwed to the bottom plate 22a of the chassis 22, the heat dissipation members 36 are fixed to the chassis 22.

Next, configurations and functions of the adhesive tapes 38 and reflection members 40, which are relevant components in this embodiment, will be described. As illustrated in FIGS. 4 and 5, the reflection member 40 and a pair of adhesive tapes 38, 38 that sandwiches the reflection member 40 therebetween are arranged in a space between the opposite surface 20c of the light guide plate 20 and the opposed surface 30a1 of the LED board 30. Each adhesive tape 38 has adhesive surfaces on a front side and a rear side. One of the adhesive tapes 38 and 38 is attached to the opposite surface 20c of the light guide plate 20 and the other one of the adhesive tapes 38 is attached to the opposed surface 30a1. Specifically, the one adhesive tape 38 is attached to a portion of the opposite surface 20c close to the light entrance surface 20a (i.e., a portion where the reflection sheet 26 is not arranged). The other adhesive tape 38 is attached to a portion of the opposed surface 30a1 where the one adhesive tape 38 overlaps in a plan view. The reflection member 40 having a sheet-like shape is arranged so as to be sandwiched between the adhesive tapes 38, 38 and attached to the respective adhesive tapes 38, 38. The adhesive tapes 38, 38 having a length equal to a long dimension of the light guide plate 20 are attached to the opposite surface 20c and the opposed surface 30a1, respectively. With this configuration, the heat dissipating portion 30a of the LED board 30 is fixed to the portion of the opposite surface 20c of the light guide plate 20 close to the light entrance surface 20a. The adhesive tapes 38, 38 are attached to the opposite surface 20c and the opposed surface 30a1, respectively, such that edges of the respective adhesive tapes 38, 38 are aligned with the light entrance surface 20a of the light guide plate 20.

The reflection members 40 are sheet-like members having light reflection properties, similar to the reflection sheet 26. As illustrated in FIG. 5, the reflection member 40 has a length (a dimension in the X-axis direction) substantially the same as the length of the adhesive tape 38. One edge of the reflection member 40 extends toward the LEDs 28 over the light entrance surface 20a of the light guide plate 20 (the extending portion is hereinafter referred to as an extending portion 40a). As illustrated in FIG. 5, the extending portion 40a extends to a position immediately below the LEDs 28. Namely, the reflection member 40 is arranged such that a surface thereof faces a space between the main light-emitting surfaces 28a of the LEDs 28 and the light entrance surface 20a of the light guide plate 20. In this configuration, a large amount of light that exits the LEDs 28 and travels toward a lower side (a heat dissipating portion 30a side) is reflected by the reflection member 40 toward the light entrance surface 20a. Therefore, light entering efficiency of light that exits the LEDs 28 and enters the light entrance surface 20a is improved.

Two-dot chain lines in the FIG. 4 indicate positions of the light guide plate 20, the LEDs 28, and the LED board 30 when the light guide plate 20 thermally expands. As described earlier, the heat dissipating portion 30a of the LED board 30 is attached to the opposite surface 20c of the light guide plate 20 and thus the LED board 30 is fixed to the light guide plate 20. The LED board 30 is slidable on the plate-like portion 36a of the heat dissipation member 36. Therefore, as illustrated in FIG. 4, if the light guide plate 20 thermally expands and the light entrance surface 20a moves outward, the LED board 30 moves outward according to the moving of the light entrance surface 20a. The LED board 30 moves by substantially the same distance as the light entrance surface moves. According to the moving of the LED board 30, the LEDs 28 that are mounted on the LED board 30 move outward by substantially the same distance as the LED board 30 moves (i.e., by the same distance as the light entrance surface 20a of the light guide plate 20 moves). According to this configuration, the distance between the main light-emitting surfaces 28a of the LEDs 28 and the light entrance surface 20a of the light guide plate 20 remains constant before and after the thermal expansion of the light guide plate 20. In a production process of the backlight unit 24, the LED boards 30 on which the LEDs 28 are mounted are fixed to the light guide plate 20 with the adhesive tapes 38 in advance. Therefore, during the production process of the backlight unit 24, a shift in position of the light guide plate 20 relative to the LED boards 30 is less likely to occur. According to this configuration, the distance between the main light-emitting surface 28a of the LEDs 28 and the light entrance surface 20a of the light guide plate 20 is less likely to change during the production process. As is described above, in the backlight unit 24, the light entrance surface 20a of the light guide plate 20 is less likely to come in contact with the LEDs 28 if the thermal expansion of the light guide plate 20 occurs or when the light guide plate 20 and the LED boards 30 are arranged in the chassis 22 in the production step. Therefore, the LEDs 28 can be arranged relatively close to the light entrance surface 20a and thus the light entering efficiency of light that is emitted from the LEDs 28 into the light entrance surface 20a is improved.

In the backlight unit 24 according to this embodiment, the LED boards 30 are attached to the light guide plate 20 with the adhesive tapes 38, and thus the LED boards 30 are fixed to the light guide plate 20. With this configuration, the distance between the LEDs 28 and the light entrance surface 20a of the light guide plate 20 is maintained. The LED board 30 is arranged so as to be slidable on the plate-like portion 36a. If the light entrance surface 20a of the light guide plate 20 thermally expands toward the LEDs 28, the LED board 30 that is fixed to the light guide plate 20 moves according to the thermal expansion of the light guide plate 20. Therefore, a distance between the LEDs 28 and the light entrance surface 20a remains constant before and after the thermal expansion. According to this configuration, a predetermined distance is not required between the LEDs 28 and the light entrance surface 20a for a supposed thermal expansion of the light guide plate 20. Therefore, the LEDs 28 can be arranged close to the light entrance surface 20a and thus the light entering efficiency of light that is emitted from the LEDs 28 into the light entrance surface 20a is improved. Furthermore, the heat dissipating portions 30a of the LED boards 30 are arranged on the heat dissipation members 36 having heat dissipation properties. According to this configuration, heat generated around the LEDs 28 is effectively dissipated via the heat dissipation members 36. In the backlight unit 24 of this embodiment, the heat dissipation properties are maintained while the light entering efficiency of light that exits the LEDs 28 and enters the light entrance surface 20a is improved.

In the backlight unit 24 according to this embodiment, pairs of the adhesive tapes 38, 38 are arranged between the opposite surface 20c of the light guide plate 20 and the opposed surfaces 30a1 of the LED boards 30. Each sheet-like reflection member 40 is arranged between the corresponding pair of the adhesive tapes 38, 38. The extending portion 40a that is one of the edge portions of the reflection member 40 extends toward the LEDs 28 over the light entrance surface 20a of the light guide plate 20. According to this configuration, light that exits the LEDs 28 and travels toward the opposed surface 30a1 is reflected by the extending portion 40a of the reflection member 40 and directed toward the light entrance surface 20a. Therefore, the light entering efficiency of light emitted from the LEDs 28 into the light entrance surface 20a is further improved.

In the backlight unit 24 according to this embodiment, the LED boards 30 may further include the mounting portions 30b. The mounting portion 30b has a plate-like shape and stands up from the opposed surface 30a1 of the heat dissipating portion 30a toward the light exit surface 20b (toward the front side). The LEDs 28 are mounted to the mounting portion 30b. In this configuration, one of the edge portions of the reflection member 40 extends to a position between the LEDs 28 and the opposed surface 30a1 (i.e., immediately below the LEDs 28). Therefore, light from the LEDs 28 is effectively reflected toward the light entrance surface 20a by the reflection member 40.

In the backlight unit 24 according to this embodiment, the LED boards 30 are made of aluminum. Namely, the LED boards 30 are components having high thermal conductivity. Therefore, heat generated from the LEDs 28 is effectively transferred to the heat dissipation members 36 via the LED boards 30.

### Second Embodiment

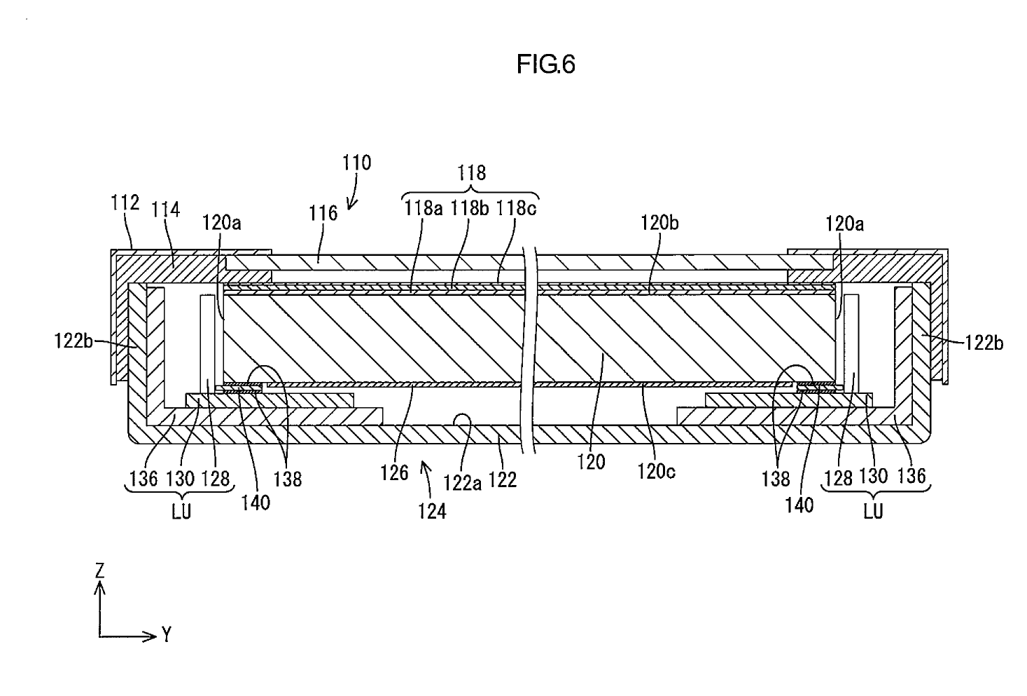

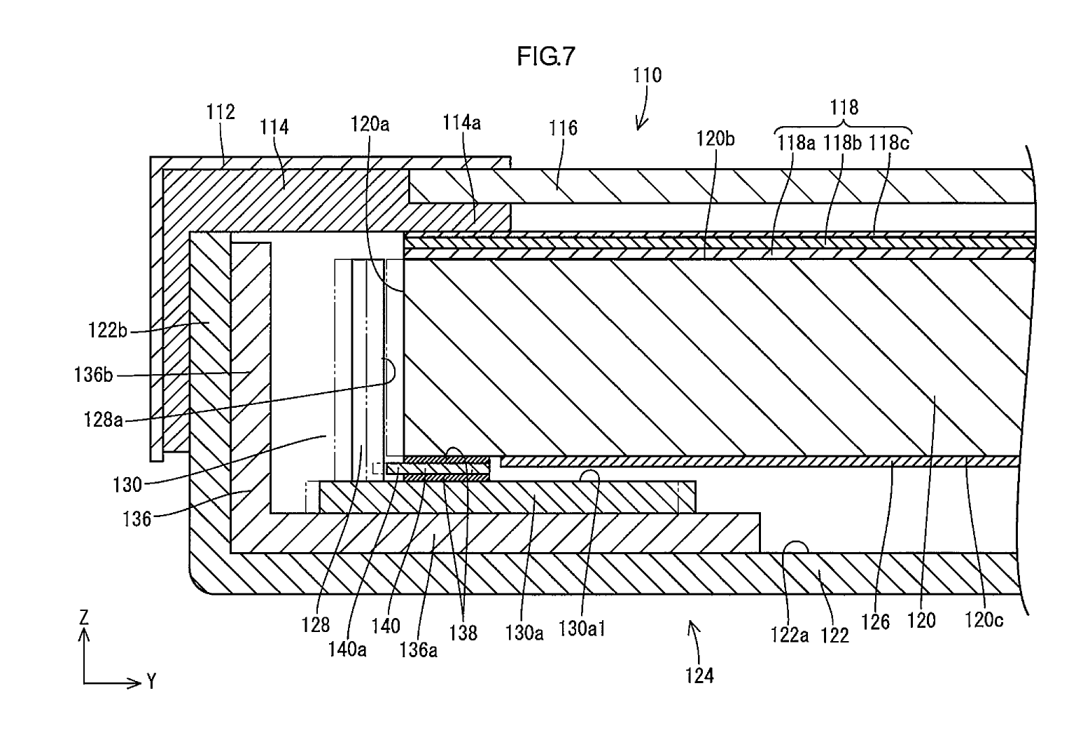

A second embodiment will described with reference to the drawings. In the second embodiment, the arrangement of LEDs 128 relative to LED boards 130 is different from the first embodiment. Other configurations are the same as the first embodiment and thus configurations, functions, and effects of those will not be described. In FIGS. 6 and 7, portions indicated by numerals including the reference numerals in FIGS. 3 and 4 with 100 added thereto have the same configurations as the portions indicated by the respective reference numerals in the first embodiment.

As illustrated in FIGS. 6 and 7, in a backlight unit 124 according to the second embodiment, the LED boards 130 do not include the mounting portions 30b that are included in the LED boards of the first embodiment. The LED boards 130 only include heat dissipating portions 130a. The LEDs 128 are mounted on the LED boards 130 so as to stand on an opposed surface 130a1 of each heat dissipating portion 130a. Specifically, the LEDs 128 are arranged on a portion of the opposed surface 130a1 so as not to correspond to an opposite surface 120c of a light guide plate 120. The LED 128 has a surface that is mounted on the LED board 130 and the surface is defined as a rear surface. The LED 128 further has a surface that is one of side surfaces thereof and the one side surface faces a light entrance surface 120a of the light guide plate 120. The side surface of the LED 128 is a main light-emitting surface 128a. That is, the LEDs 128 are so-called side-emitting type LEDs. If an LED board has the mounting portion 30b and has an L-like shape in a cross section such as the LED board of the first embodiment, a bending work is required in advance to shape a plate member into an LED board having an L-like cross-section during a production process of the backlight unit 124. According to this embodiment, the LED board 130 only includes the heat dissipating portion 130a having a plate-like shape. Therefore, the above-described bending work is not required for a plate member for the LED board 130 during the production process of the backlight unit 24. Accordingly, the production cost for the LED boards 130 is reduced and the production process for the LED boards 130 is simplified.

### Third Embodiment

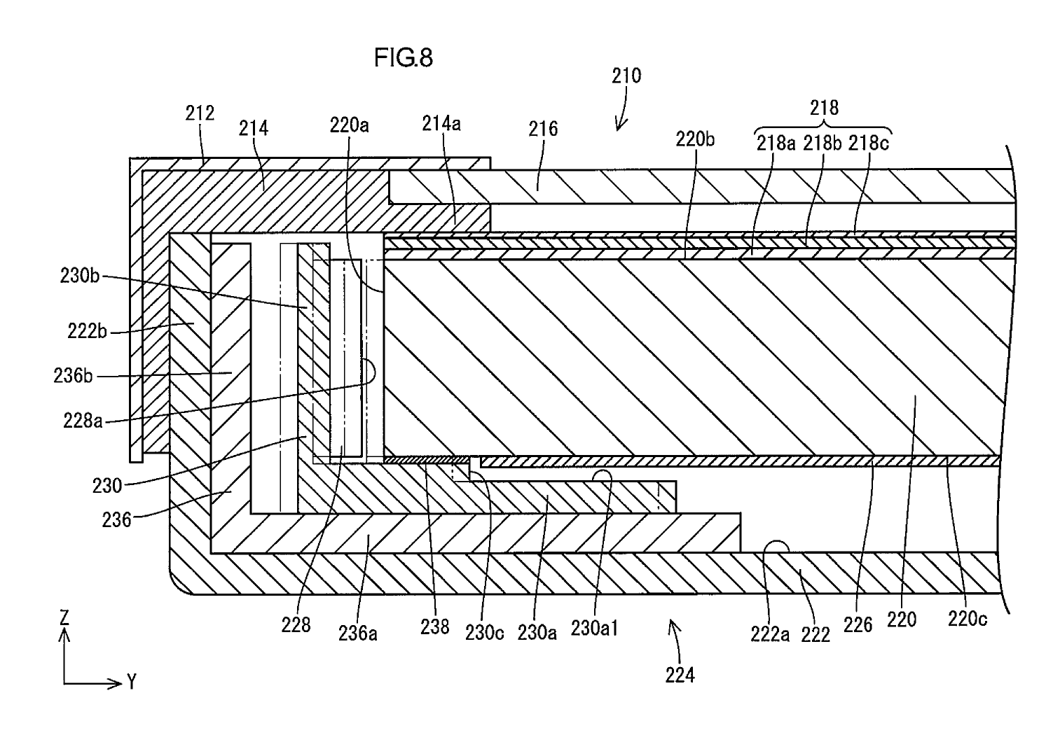

A third embodiment will be described with reference to the drawings. In the third embodiment, an attachment configuration of opposed surfaces 230a1 of LED boards 230 to an opposite surface 220c of a light guide plate 220 is different from the first embodiment. Other configurations are the same as the first embodiment and thus configurations, functions, and effects of those will not be described. In FIG. 8, portions indicated by numerals including the reference numerals in FIG. 4 with 200 added thereto have the same configurations as the portions indicated by the respective reference numerals in the first embodiment.

As illustrated in FIG. 8, in a backlight unit 224 according to the third embodiment, each of the LED boards 230 includes a step 230c that is on a portion of the opposed surface 230a1 of a heat dissipating portion 230a. In this configuration, a part of the heat dissipating portion 230a is located close to the opposite surface 220c of the light guide plate 220. Between the opposite surface 220c and the opposed surface 230a1, an adhesive tape 238 is arranged. A front surface and a rear surface of the adhesive tape 238 are attached to the opposite surface 220c and the opposed surface 230a1, respectively. Accordingly, the LED boards 230 are fixed to the light guide plate 220. According to the configuration in which only one adhesive tape 238 is arranged between the opposite surface 220c and the corresponding opposed surface 230a1, the LED board 230 is easily fixed to the light guide plate 220 during the production process of the backlight unit 224 in comparison to the configuration of the first embodiment. If the light entrance surface 220a of the light guide plate 220 thermally expands toward the LEDs 228, the LED board 230 that is fixed to the light guide plate 220 moves according to the moving of the light entrance surface 220a. Therefore, a distance between the LEDs 228 and the light entrance surface 220a remains substantially constant before and after the thermal expansion.

### Fourth Embodiment

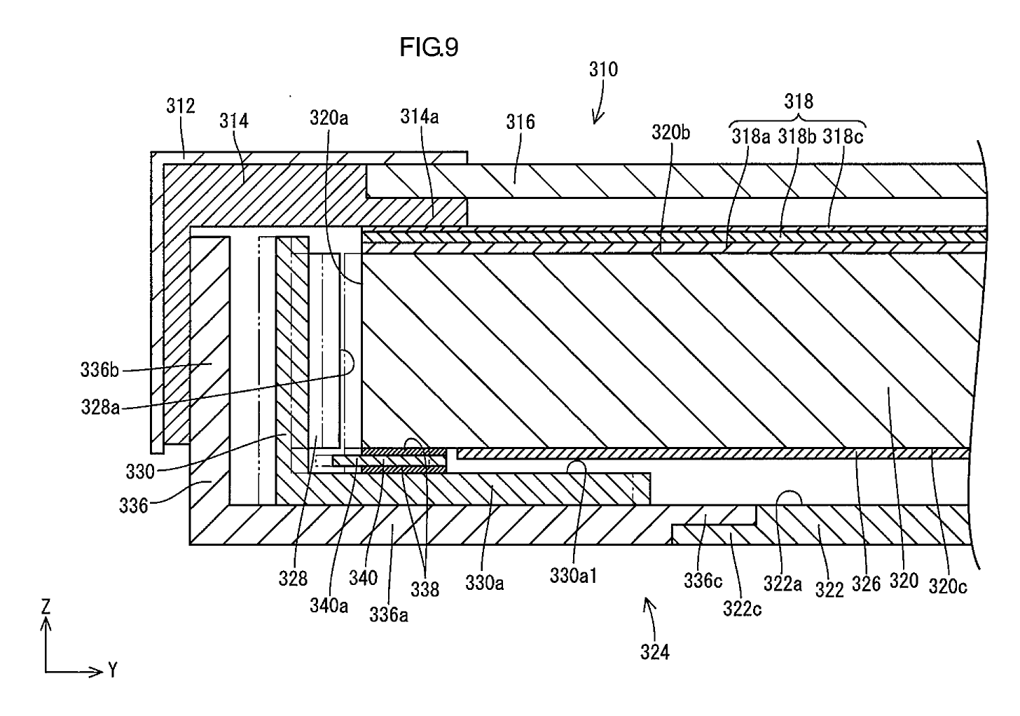

A fourth embodiment will be described with reference to the drawings. In the fourth embodiment, the attachment configuration of heat dissipation members 330 to a chassis 322 is different from the first embodiment. Other configurations are the same as the first embodiment and thus configurations, functions, and effects of those will not be described. In FIG. 9, portions indicated by numerals including the reference numerals in FIG. 4 with 300 added thereto have the same configurations as the portions indicated by the respective reference numerals in the first embodiment.

As illustrated in FIG. 9, in a backlight unit 324 according to the fourth embodiment, heat dissipation members 336 constitute part of the chassis 322. Namely, plate-like portions 336a of the heat dissipation members 336 constitute portions of a bottom plate 322a of the chassis 322 and stand-up portions 336b of the heat dissipation members 336 constitute peripheral walls of the chassis 322. Specifically, the plate-like portions 336a constitute end portions of a short dimension of the bottom plate 322a (i.e., the Y-axis direction). The stand-up portions 336b constitute long-side peripheral walls that extend from respective long edges of the chassis 322 toward the front side. Each of the heat dissipation members 336 includes a heat dissipation member 336 side connecting portion 336c at a tip of the plate-like portion 336a thereof. The connecting portion 336c is connected to a chassis connecting portion 322c of the bottom plate 322a of the chassis 322 with screws. Namely, the heat dissipation members 336 are part of the chassis 322. In the embodiment having such a configuration, the plate-like portions 336a of the heat dissipation members 336 are arranged so as to be in the same level with the bottom plate 322a of the chassis 322 (i.e., positions thereof with respect to the Z-axis direction are aligned). With this configuration, the thickness of the backlight unit 324 is reduced in comparison to the configuration of the first embodiment.

### Fifth Embodiment

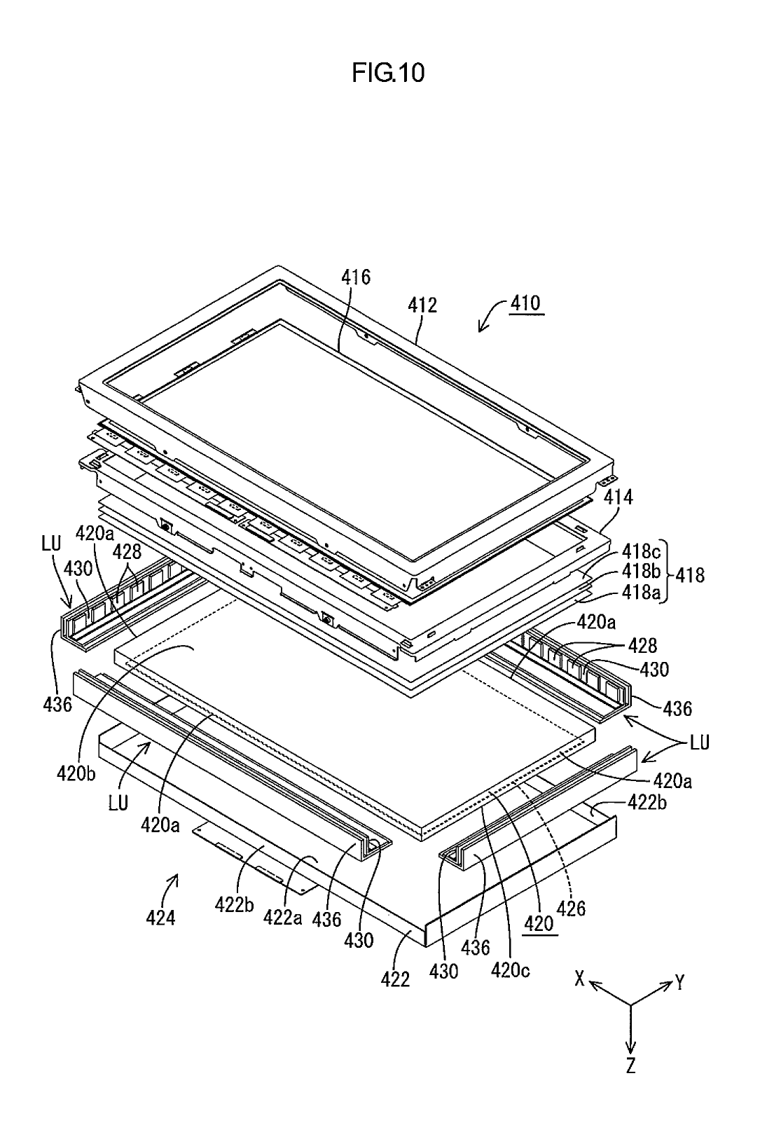

A fifth embodiment will be described with reference to the drawings. In the fifth embodiment, the number and the arrangement of the LED units LU are different from the first embodiment. Other configurations are the same as the first embodiment and thus configurations, functions, and effects of those will not be described. In FIG. 10, portions indicated by numerals including the reference numerals in FIG. 2 with 400 added thereto have the same configurations as the portions indicated by the respective reference numerals in the first embodiment.

As illustrated in FIG. 10, in a backlight unit 424 according to the fifth embodiment, all peripheral side surfaces of a light guide plate 420 are light entrance surfaces 420a, and the LED units LU are arranged corresponding to all peripheral sides of the light guide plate 420. Two of the LED units LU arranged close to long-side peripheral surfaces of the light guide plate 420 each have a long dimension smaller than a long-side dimension of the light guide plate 420. In other two LED units LU arranged close to short-side peripheral surfaces of the light guide plate 420, plate-like portions of heat dissipation members 436 and heat dissipating portions of LED boards 430 each have a short-side dimension that is smaller than those in the first embodiment. According to this configuration, although the LED units LU are arranged corresponding to all of the peripheral sides of the light guide plate 420, the plate-like portions of the heat dissipation members 436 and the heat dissipating portions of the LED boards 430 in the respective LED units LU do not contact each other on an opposite surface 420c side of the light guide plate 420. Thus, the LED units LU can be arranged such that LEDs 428 and the light entrance surfaces 420a are located close to one another. Adhesive tapes are less likely to scratch or damage the light guide plate 420. Therefore, even in the configuration of the LED units LU fixed corresponding to multiple peripheral sides of the light guide plate 420 with the adhesive tapes, functions of the light guide plate 420 are not deteriorated. In the backlight unit 424 according to this embodiment, the LED unit LU is arranged corresponding to every peripheral side surface of the light guide plate 420 so that brightness of the backlight unit 424 is improved.

Modifications of the above embodiments will be listed below.

(1) In each of the above embodiments, the heat dissipating portions of the LED boards are in surface-contact with the plate-like portions of the respective heat dissipation members. However, the LED boards and the heat dissipation members may have other configurations as long as the LED boards are arranged so as to be slidable in the direction perpendicular to the light entrance surface relative to the respective heat dissipation members. For example, the heat dissipating portion may have an oval screw hole with a major axis along the direction perpendicular to the light entrance surface. Further, the plate-like portion of the heat dissipation member may have a screw hole. With a screw inserted in the both holes, the heat dissipation member may be fixed to the LED board.

(2) In each of the above embodiments, each adhesive tape is attached on the opposite surface such that one of the side edges of the adhesive tape is aligned with the light entrance surface. However, the position of the adhesive tape with respect to the opposite surface is not limited thereto.

(3) In each of the above embodiments, the adhesive tapes having the same dimension as the long-side dimension of the light guide plate are attached to the opposite surface of the light guide plate. However, the adhesive tapes may be attached to part of the opposite surface or attached to the opposite surface at intervals.

(4) Other than the above embodiments, the arrangement of the adhesive tapes with respect to the opposite surface and the opposed surfaces can be modified as appropriate.

(5) Other than the above embodiments, components arranged between the opposite surface and the opposed surfaces can be modified as appropriate.

(6) In each of the above embodiments, the liquid crystal display device includes a cabinet. However, the aspect of the present invention can be applied to the liquid crystal display device without a cabinet.

(7) In each of the above embodiments, the liquid crystal display device including the liquid crystal panel as the display panel is used. However, the aspect of the present invention can be applied to display devices including other types of display panels.

The embodiments have been described in detail. However, the above embodiments are only some examples and do not limit the scope of the claimed invention. The technical scope of the claimed invention includes various modifications of the above embodiments.

The technical elements described in this specification and the drawings may be used independently or in combination to achieve the technical benefits. The combinations are not limited to those in original claims. With the technologies described in this specification and the drawings, multiple objects may be accomplished at the same time. However, the technical benefits can be achieved by accomplishing even only one of the objects.

### EXPLANATION OF SYMBOLS

TV: Television device, Ca, Cb: Cabinet, T: Tuner, S: Stand, 10, 110, 210, 310, 410: liquid crystal display device, 12, 112, 212, 312, 412: bezel, 14, 114, 214, 314, 414: frame, 16, 116, 216, 316: liquid crystal panel, 18, 118, 218, 318, 418: optical member, 20, 120, 220, 320, 420: light guide plate, 20a, 120a, 220a, 320a, 420a: light entrance surface, 20b, 120b, 220b, 320b, 420b: light exit surface, 20c, 120c, 220c, 320c, 420c: opposite surface, 22, 122, 222, 322, 422: chassis, 24, 124, 224, 324, 424: backlight unit, 26, 126, 226, 326, 426: reflection sheet, 28, 128, 228, 328, 428: LED, 30, 130, 230, 330, 430: LED board, 36, 136, 236, 336, 436: heat dissipation member, 38, 138, 238, 338: adhesive tape, 40, 140, 340: reflection member.

1. A lighting device comprising:
a light source;
a light guide plate including a plate surface configured as a light exit surface, another plate surface as an opposite surface being opposite from the light exit surface, and at least one side surface configured as a light entrance surface, the light guide plate being arranged such that the light entrance surface is opposite the light source and configured to guide light from the light source;
a heat dissipation member having a heat dissipation property and including at least one plate-like portion arranged adjacent to the opposite surface and;
a light source board having the light source mounted on a part thereof and including an opposed surface that is opposed to the opposite surface, the light source board being arranged on the plate-like portion so as to be slidable in a direction perpendicular to the light entrance surface; and
an adhesive tape arranged between the opposite surface and the opposed surface and with which the light source board is attached to the light guide plate.

2. The lighting device according to claim 1, wherein
the adhesive tape includes a pair of adhesive tapes between the opposite surface and the opposed surface,
the lighting device further comprising a reflection member arranged between the pair of the adhesive tapes, and
the reflection member includes an edge portion that extends closer to the light source than the light entrance surface of the light guide plate is.

3. The lighting device according to claim 2, wherein the light source board includes a mounting portion where the light source is mounted, the mounting portion having a plate-like shape and extending from the opposed surface toward a light exit surface side.

4. The lighting device according to claim 1, wherein the light source is mounted on the opposed surface in a standing position, the light source including a light emitting surface on a side surface thereof.

5. The lighting device according to claim 1, further comprising a chassis holding at least the light source, the light guide plate, and the light source board, wherein
the heat dissipation member is configured as a portion of the chassis.

6. The lighting device according to claim 1, wherein the light source board is made of aluminum.

7. The lighting device according to claim 1, the light guide plate includes a plurality of side surfaces each configured as the light entrance surface.

8. A display device comprising:
a display panel displaying an image using light from the lighting device according to claim 1.

9. The display device according to claim 8, wherein the display panel is a liquid crystal panel including liquid crystals.

10. A television device comprising the display device according to claim 8.
